(19) United States
(12) Patent Application Publication
(10) Pub. No.: US 2024/0091963 A1
(43) Pub. Date: Mar. 21, 2024

(54) Length Adjustable Robotic Limb with Multiple Degrees of Freedom

(71) Applicant: Sarcos Corp., Salt Lake City, CT (US)

(72) Inventors: Fraser M. Smith, Salt Lake City, UT (US); Marc X. Olivier, Salt Lake City, UT (US); Michael J. Myers, Salt Lake City, UT (US)

(21) Appl. No.: 17/946,698

(22) Filed: Sep. 16, 2022

(51) Int. Cl. B25J 18/04; B25J 9/00; B25J 17/00

(52) U.S. Cl. CPC B25J 18/04; B25J 9/0006; B25J 17/00

(57) ABSTRACT

A length adjustable robotic limb comprises a first joint assembly, a second joint assembly, and a structural member extending between the first joint assembly and the second joint assembly, the structural member defining a longitudinal axis. An adjustable interface can be provided between the structural member and one of the first and second joint assemblies. The adjustable interface can facilitate adjustment of a length between the first and second joint assemblies. A rotational interface between the structural member and one of the first and second joint assemblies can facilitate relative rotation between the first joint assembly and the second joint assembly about the longitudinal axis in a degree of freedom corresponding to medial/lateral rotation of a portion of a human limb.

### BACKGROUND

A wide variety of exoskeleton, humanoid, robotic arms, and other robots or robotic systems exist which perform tasks in a variety of situations and applications. Robotic exoskeletons in particular are wearable electromechanical devices that have been developed as augmentative devices to enhance the physical performance of the wearer or as orthotic devices for gait rehabilitation or locomotion assistance. Robotic exoskeletons have potential applications in multiple different fields and may be used by a variety of different users.

In some instances, a single robotic skeleton may be desired for use by a plurality of different users. However, these different users can have different sizes compared to one another. For example, one user may be taller than another user and may therefore have longer limbs than another user. These different sizes of users, therefore, may not fit a single exoskeleton.

### SUMMARY

Given the above, it is desirable that limbs of a robotic skeleton be length adjustable to accommodate users of different sizes. Furthermore, it is desirable that a robotic limb be length adjustable while also providing multiple degrees of freedom to accommodate movement of the user operating the robotic skeleton.

Accordingly, in one example of the present disclosure, A length adjustable robotic limb a first joint assembly comprising a first joint of the robotic limb, a second joint assembly comprising a second joint of the robotic limb, and a structural member extending between the first joint assembly and the second joint assembly. The structural member can define a longitudinal axis, and the structural member can be operable to connect with the first joint assembly and the second joint assembly. The robotic limb can further comprise an adjustable interface between the structural member and the first joint assembly or between the structural member and the second joint assembly. The adjustable interface can facilitate adjustment of a length between the first joint assembly and the second joint assembly along the longitudinal axis. The robotic limb can also comprise a rotational interface between the structural member and the first joint assembly or between the structural member and the second joint assembly. The rotational interface can be operable to facilitate relative rotation between the first joint assembly and the second joint assembly about the longitudinal axis in a degree of freedom corresponding to medial/lateral rotation of a portion of a human limb.

In some examples, the adjustable interface can comprise a mechanical lock operable to selectively lock the structural member to the first joint assembly or the second joint assembly in one of a plurality of length adjustment positions. The mechanical lock can comprise a clamp disposed on the first joint assembly or the second joint assembly. The clamp can be configured to engage the structural member at one of the plurality of length adjustment positions to selectively lock the structural member to the first joint assembly or the second joint assembly.

In some examples, the structural member comprises a cylindrical shaft. The adjustable interface can further comprise a plurality of locking interfaces disposed at intervals along a length of the shaft. The plurality of locking interfaces can each comprise an array of indents extending circumferentially around the shaft. The plurality of locking interfaces can correspond with the plurality of length adjustment positions. The clamp can be configured to engage the shaft at one of the locking interfaces to selectively lock the shaft to the first joint assembly or the second joint assembly at the one of the plurality of length adjustment positions. The clamp can comprise an array of depressions. The array of depressions can accommodate spherical balls and can correspond to the array of indents of each of the plurality of locking interfaces. The clamp can be configured to engage the array of depressions accommodating the spherical balls with the array of indents of one of the plurality of locking interfaces.

In some examples, the adjustable interface can comprise a plurality of locking interfaces along a length of the structural member. The plurality of locking interfaces can correspond to a plurality of length adjustment positions. The adjustable interface can comprise a mechanical lock comprising a clamp disposed on the first joint assembly or the second joint assembly. The clamp can be configured to engage the structural member at one of the locking interfaces. The plurality of locking interfaces can each comprise longitudinal slots extending along a length of the shaft and a plurality of lateral notches extending perpendicular from the longitudinal slots. The plurality of lateral notches can correspond to a plurality of length adjustment positions. The adjustable interface can comprise a mechanical lock comprising a fastener operable to couple the structural member to the first joint assembly or the second joint assembly at one of the plurality of lateral notches.

In some examples, the adjustable interface can comprise a mechanical lock comprising at least one fastener configured to extend through the structural member and the first joint assembly or extend through the structural member and the second joint assembly at one of the plurality of length adjustment positions to selectively lock the structural member to the first joint assembly or the second joint assembly.

In some examples the adjustable interface can comprise a plurality of fastener guides disposed on the first joint assembly or the second joint assembly. The plurality of fastener guides can correspond to a plurality of length adjustment positions. The adjustable interface can comprise a mechanical lock comprising at least one fastener configured to extend through the structural member and through the first joint assembly or the second joint assembly at one of the plurality of fastener guides. The at least one fastener can comprise a first and second fastener. The plurality of fastener guides can each comprise two openings parallel to one another that are each operable to receive the first and second fastener, respectively. The adjustable interface can comprise a first and second locking interface disposed on the structural member. Each of the first and second locking interfaces can comprise a through hole to receive the first and second fastener, respectively. The structural member can comprise an alignment channel extending longitudinally along the structural member. The second joint assembly can comprise a biased spherical ball operable to extend into the alignment channel and to circumferentially align the two openings of the plurality of fastener guides and the first and second locking interfaces of the structural member.

In some examples, the first joint can be a hip joint of the robotic limb, and the second joint can be a knee joint of the robotic limb. The structural member can comprise an upper leg structural member between the hip joint and the knee joint.

In some examples, the length adjustable robotic limb can further comprise a third joint assembly disposed at an ankle joint of the robotic limb, and a lower leg structural member extending between the second joint assembly and the third joint assembly. The lower leg structural member can define a lower leg longitudinal axis and can be operable to connect with the second joint assembly and the third joint assembly. The length adjustable robotic limb can further comprise a second adjustable interface between the lower leg structural member and the second joint assembly or between the structural member and the third joint assembly. The second adjustable interface can facilitate adjustment of a length between the second joint assembly and the third joint assembly along the lower leg longitudinal axis. The length adjustable robotic limb can comprise a second rotational interface between the lower structural member and the second joint assembly or between the lower structural member and the third joint assembly. The second rotational interface can be operable to facilitate relative rotation between the second joint assembly and the third joint assembly about the lower leg longitudinal axis in a degree of freedom corresponding to medial/lateral rotation of a portion of a human limb. In some examples, the adjustable interface and the second adjustable interface are independently adjustable.

In some examples, the rotational interface comprises a fixed member and a rotatable member disposed at the first joint assembly or the second joint assembly. The rotatable member can be operable to rotate relative to the fixed member. The structural member can be connected to the rotatable member such that rotation of the rotatable member facilitates the relative rotation between the first joint assembly and the second joint assembly about the longitudinal axis.

In some examples, the rotational interface can further comprise a bearing disposed between the fixed member and the rotatable member. The rotational interface can further comprise an actuator operable to rotate the rotatable member relative to the fixed member.

In some examples, a length adjustable robotic limb can comprise a first joint assembly comprising a first joint of the robotic limb and a structural member extending from the first joint assembly and defining a longitudinal axis. An adjustable interface can be provided between the first joint assembly and the structural member. The adjustable interface can facilitate adjustment of a length between the first joint assembly and a second joint assembly connected to the structural member along the longitudinal axis. A rotational interface can be provided between the first joint assembly and the structural member. The rotational interface can be operable to facilitate relative rotation between the first joint assembly and the structural member about the longitudinal axis in a degree of freedom corresponding to medial/lateral rotation of a portion of a human limb.

In some examples, the adjustable interface comprises a plurality of locking interfaces along a length of the structural member. The plurality of locking interfaces can correspond to a plurality of length adjustment positions. The plurality of locking interfaces can each comprise longitudinal slots extending along a length of the shaft and a plurality of lateral notches extending perpendicular from the longitudinal slots. The plurality of lateral notches corresponding to the plurality of length adjustment positions. The adjustable interface can comprise a mechanical lock comprising a fastener operable to couple the structural member to the first joint assembly at one of the plurality of lateral notches.

In some examples, the rotational interface can comprise a fixed member and a rotatable member disposed at the first joint assembly, the rotatable member operable to rotate relative to the fixed member, wherein the structural member is connected to the rotatable member such that rotation of the rotatable member facilitates the relative rotation between the first joint assembly and the second joint assembly about the longitudinal axis. The rotational interface can further comprise a bearing disposed between the fixed member and the rotatable member. The rotational interface can further comprise an actuator operable to rotate the rotatable member relative to the fixed member.

In some examples, a method of adjusting a length of a robotic limb can comprise connecting a structural member of a robotic limb to a first joint assembly disposed at a first joint of the robotic limb, selectively locking the structural member to the first joint assembly at a first position of a plurality of length adjustment positions, and unlocking the structural member from the first position and selectively locking the structural member to the first joint assembly at a second position of the plurality of length adjustment positions. The structural member can be rotatably coupled to the first joint assembly or to a second joint assembly disposed at a second joint of the robotic limb.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1A is an isometric view of a robotic system, namely a wearable robotic exoskeleton, having at least one actuator joint assembly in accordance with an example of the present disclosure;

FIG. 1B is another isometric view of the robotic system of FIG. 1A;

FIG. 2A is an isometric view of a robotic leg of the robotic system shown in FIG. 1A;

FIG. 2B is an isometric view of the robotic leg shown in FIG. 2A at a middle length configuration;

FIG. 2C is an isometric view of the robotic leg shown in FIG. 2A at an extended length configuration;

FIG. 3A is an isometric view of a lower portion of the robotic leg shown in FIG. 2A;

FIG. 3B is a front view of the lower portion of the robotic leg shown in FIG. 3A;

FIG. 3C is a section view of the lower portion of the robotic leg taken along the line A-A in FIG. 3B;

FIG. 3D is another isometric view of the lower portion of the robotic leg shown in FIG. 3A;

FIG. 3E is a rear view of the lower portion of the robotic leg shown in FIG. 3A;

FIG. 3F is a section view of the lower portion of the robotic leg taken along the line E-E in FIG. 3E;

FIG. 3G is a section view of the lower portion of the robotic leg taken along the line F-F in FIG. 3F;

FIG. 4A is an isometric view of an upper portion of the robotic leg shown in FIG. 2A;

FIG. 4B is a side view of the upper portion of the robotic leg shown in FIG. 4A;

FIG. 4C is a section view of an upper portion robotic leg taken along the line G-G in FIG. 4B;

FIG. 4D is a rear view of the upper portion of the robotic leg shown in FIG. 4A;

FIG. 4E is a section view of the upper portion of the robotic leg taken along the line H-H in FIG. 4D;

FIG. 4F is a detail view indicated by the area J in FIG. 4E;

FIG. 5A is an isometric view of an upper portion of a robotic leg similar to the robotic leg shown in FIG. 2A;

FIG. 5B is a rear view of the upper portion of the robotic leg shown in FIG. 5A;

FIG. 5C is an exploded isometric view of the robotic leg shown in FIG. 5A;

FIG. 5D is a section view of the upper portion of the robotic leg taken along the line B-B in FIG. 5B; and

FIG. 5E is a detail view indicated by the area C in FIG. 5D.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

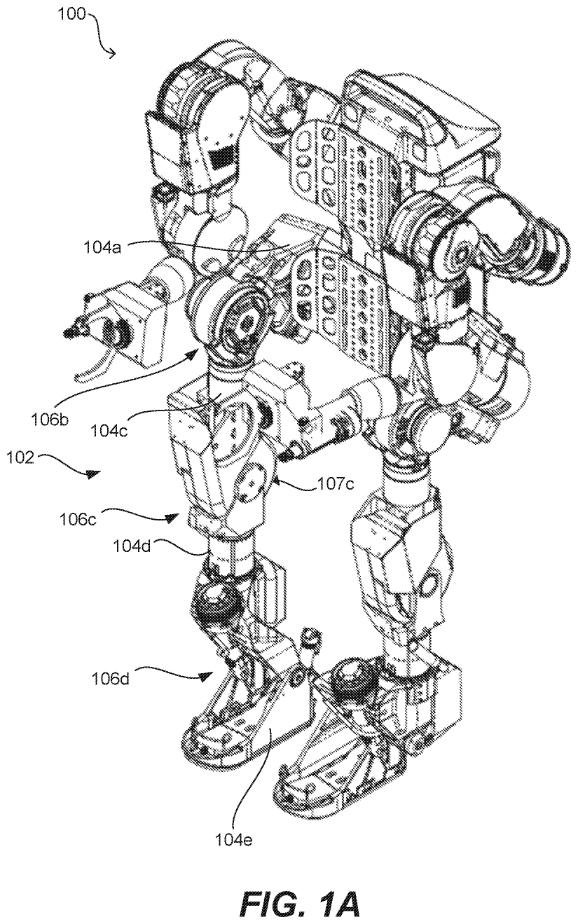

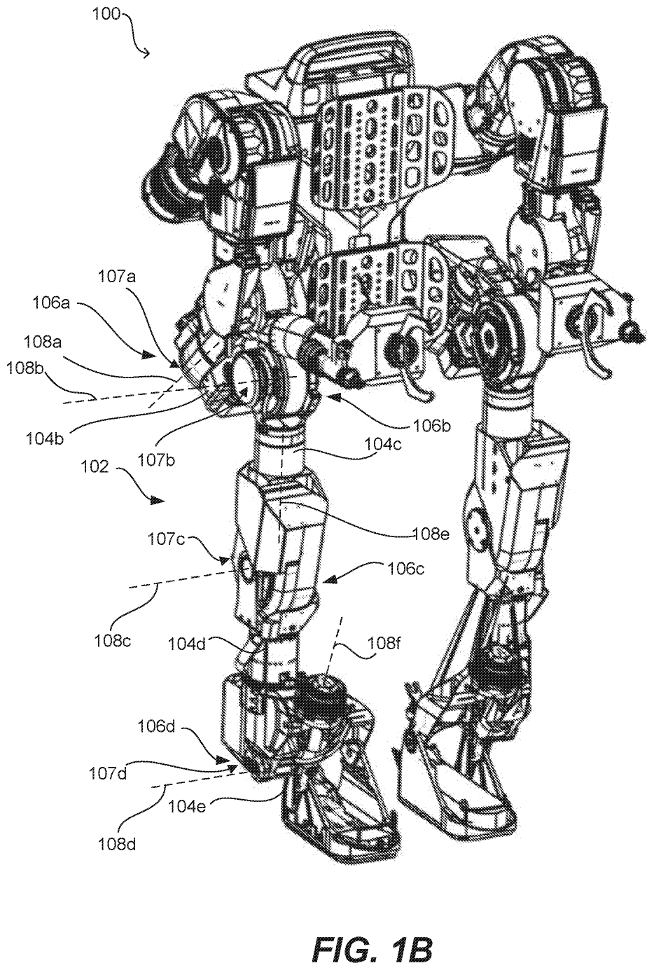

One example of a robotic system 100 is generically and graphically illustrated in FIGS. 1A and 1B. The robotic system 100 is shown in the form of an exoskeleton, and particularly an exoskeleton wearable by a user about the user's body. However, this is not intended to be limiting in any way as the concepts discussed herein can be applicable to and incorporated into or implemented with various other types of robotic systems and/or devices, such as exoskeletons (both upper and lower body exoskeletons), humanoid robots or robotic devices, teleoperated robots or robotic devices, robotic arms, unmanned ground robots or robotic devices, master/slave robots or robotic devices (including those operable with or within a virtual environment), and any other types as will be apparent to those skilled in the art. In other words, with the robotic system 100 in the form of an exoskeleton as an example, the exoskeleton(s) as disclosed herein can be configured as a full-body exoskeleton, such as that shown in FIGS. 1A and 1B, or as only a lower body exoskeleton (e.g., some or all of the lower body portion of the exoskeleton of FIGS. 1A and 1B), or as only an upper body exoskeleton (e.g., some or all of the upper body portion of the exoskeleton of FIGS. 1A and 1B).

The robotic system 100 can comprise one or more actuator joint assemblies that provide and facilitate movement of the robotic system 100 in one or more degrees of freedom. Some or all of the actuator joint assemblies can comprise one or more actuators to facilitate the movement about the one or more degrees of freedom.

A “joint assembly” refers to a structure or assembly at a joint between two or more structural members. The structure or assembly of the joint assembly is configured to connect the two or more structural members at the joint. The joint assembly can be configured to facilitate movement of the two or more structural members relative to one another about one or more axes. Such movement can include translation and/or rotation of the two or more structural members relative to one another in one or more degrees of freedom.

An “actuator joint assembly” comprises a joint assembly having one or more actuators configured to be actuatable to cause relative movement between the two or more structural members about one or more axes in one or more degrees of freedom.

A “joint” is defined as a place where two or more members are joined together. Members can be joined together at a joint such that there is no relative movement between the members or such that the members can move relative to one another in one or more degrees of freedoms.

A “structural member” is a rigid support that is a constituent part of a structure or system. For example, in the robotic system described herein, a structural member are members or supports of the robotic system that can correspond to limb portions of a human body, such as an upper leg, a lower leg, an upper arm, etc. that extend between and are connected at joints of the robotic system.

In some examples, the robotic system 100 can comprise an upper exoskeleton and a lower exoskeleton, each having left and right exoskeleton limbs. With reference to the lower exoskeleton limb 102 as an example, exoskeleton limb 102 can comprise a plurality of rotatably coupled support members 104a-e that can connect together at joints, and that are rotatable in one or more degrees of freedom at the joints via one or more joint assemblies. Some of the joint assemblies may or may not comprise an actuator joint assembly having one or more actuators. Indeed, some of the joint assemblies can comprise an actuator joint assembly that is a powered joint assembly (i.e., an active joint assembly), while others of the joint assemblies can be an unpowered joint assembly (facilitating movement between members joined at the joint assembly via a force applied by a human (i.e., a passive joint assembly)). Some joint assemblies can have an actuator that facilitates movement between members in one degree of freedom while facilitating movement via a force applied by a human in another degree of freedom. The support members 104a-e can each comprise a single rigid structural support or a collection of rigid, structural supports, that are directly or indirectly coupled together, that extend(s) from a joint or that extend(s) between two joints within the limb 102 of the exoskeleton, or that link the joints together, much like the bones in the human body extending from or between various joints.

The support members 104a-e can be respectively coupled together for relative movement at respective joints, such via the joint assemblies 106a-d, each of these defining and providing one or more degrees of freedom about a respective axes of rotation 108a-f. The rotational degrees of freedom about the axes of rotation 108a-f can correspond to one or more degrees of freedom of the human leg. For example, the rotational degrees of freedom about the axes 108a-f can correspond to hip abduction/adduction, hip flexion/extension, hip medial/lateral rotation, knee flexion/extension, knee medial/lateral rotation, ankle flexion/extension, ankle medial/lateral rotation, and ankle inversion/eversion.

Similarly, although not shown, degrees of freedom about respective axes of rotation within an upper body exoskeleton can correspond to one or more degrees of freedom of a human arm. For example, the degrees of freedom about the axes of rotation in an upper body exoskeleton limb can correspond to shoulder abduction/adduction, shoulder flexion/extension, shoulder medial/lateral rotation, elbow flexion/extension, elbow pronation/supination, and wrist flexion/extension. A degree of freedom corresponding to wrist abduction/adduction can also be included, as desired.

A human user or operator may use or interact with the exoskeleton robotic system 100 by interfacing with the robotic system 100. This can be accomplished in a variety of ways. For example, an operator may interface with the robotic system 100 by placing his or her foot into a foot portion of the system, where the foot of the operator can be in contact with a corresponding force sensor. Portions of the human operator can also be in contact with other force sensors of the exoskeleton robotic system 100 located at various locations of the robotic system 100. For example, a hip portion of the robotic system 100 can have one or more force sensors configured to interact with the operator's hip. The operator can be coupled to the robotic system 100 by a waist strap or other appropriate coupling device or system. The operator can be further coupled to the robotic system 100 by a foot strap or other foot securing mechanism or system (e.g., a boot and binding system). In one aspect, various force sensors can be located about a hip, knee and/or ankle portion of the robotic system 100, corresponding to respective parts of the operator. While reference is made to sensors disposed at specific locations on or about the robotic system 100, it should be understood that position and/or force and/or other types of sensors can be strategically placed at numerous locations on or about the robotic system 100 in order to facilitate proper operation of the robotic system 100.

As indicated above, the robotic system 100 can comprise various exoskeleton limbs as part of the full body exoskeleton shown. The full body exoskeleton can comprise an upper body exoskeleton portion and a lower body exoskeleton portion operable with the upper body exoskeleton portion, with each portion comprising one or more degrees of freedom of movement facilitated by one or more joint assemblies, including one or more actuator joint assemblies, some of which can comprise a passive or quasi-passive actuator. Each of the upper and lower body exoskeleton portions can comprise left and right exoskeleton limbs.

In the example shown, the right exoskeleton limb 102, which is part of the lower body exoskeleton portion, can comprise a plurality of lower body support members 104a-e and joints 107a-d. The support members 104a-e can be coupled together as shown for relative movement about a plurality of respective joints 107a-d defining a plurality of degrees of freedom about respective axes of rotation 108a-f. The right exoskeleton limb 102 can comprise a plurality of actuator joint assemblies (e.g., see joint assemblies 106a, 106b, 106c and 106d) facilitating the connection of the support members 104a-e and the relative movement of the support members 104a-e at the joints 107a-d.

As indicated, a joint assembly can facilitate movement of the support members 104a-e in one or more degrees of freedom. As one example, the right limb 102 of the exoskeleton robotic system 100 shown can comprise the joint assembly 106c, which can comprise the right knee joint 107c operable to facilitate movement of the robotic system 100 in a degree of freedom corresponding to a knee flex/extend degree of freedom in a human and in a degree of freedom corresponding to knee medial/lateral rotation degree of freedom in a human. In another example, the right limb 102 of the exoskeleton robotic system 100 shown can comprise an actuator joint assembly 106a, which can comprise the hip joint 107a operable to facilitate movement of the robotic system 100 in a degree of freedom corresponding to a hip abduction/adduction degree of freedom of a human. In still another example, the right limb 102 of the exoskeleton robotic system 100 shown can comprise an actuator joint assembly 106b, which can comprise the hip joint 107b operable to facilitate movement of the robotic system 100 in degrees of freedom corresponding to a hip flex/extend and a hip medial/lateral rotation degree of freedom of a human. In still another example, the right limb 102 of the exoskeleton robotic system 100 shown can comprise an actuator joint assembly 106d, which can comprise the ankle joint 107d operable to facilitate movement of the robotic system 100 in degrees of freedom corresponding to an ankle flex/extend and an ankle medial/lateral rotation degree of freedom of a human.

It will be appreciated, although not detailed herein, that the robotic system 100 can comprise other joint systems having respective joint assemblies at various joints. For example, the exoskeleton shown can comprise other joints, such as joints of the lower left extremity and joints of the upper left and right extremities of the exoskeleton. A joint assembly can comprise each of these joints, and each joint assembly can define and provide one or more degrees of freedom about a respective axis or axes of rotation.

As a general overview, joint assemblies 106a-d can be associated with various degrees of freedom of the exoskeleton to facilitate movement of the members 104a-e in the respective degrees of freedom. The robotic system 100 as an exoskeleton can be manipulated by a human operator as mentioned above. Different operators that use the robotic system 100 can have varying sizes. For example, one operator that uses the robotic system 100 can be taller than another operator and may have longer legs and/or arms than the other operator. Accordingly, the robotic system 100 can be configured to be adjustable, such that operators of different sizes can use the robotic system 100. For example, a leg of the robotic system 100, such as the right leg 102 can be configured, such that the length of the leg can be adjustable to accommodate operators having different leg lengths. In this example, the right leg 102 can be adjustable while still providing the degrees of freedom between the respective members 104a-e of the robotic system. Similarly, a left leg, arms, feet, or other components of the robotic system can also be adjustable to facilitate operators of different sizes.

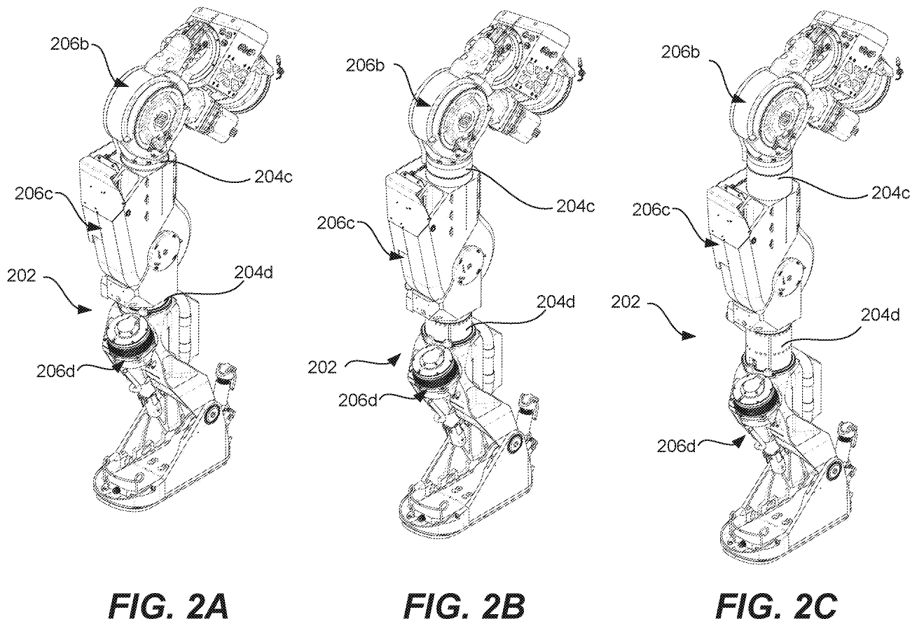

With continued reference to FIGS. 1A-1B, FIGS. 2A-2C show an example of a length adjustable robotic leg of the exoskeleton robotic system 100 of FIG. 1 that can be adjustable to different lengths. In FIGS. 2A-2C, a robotic leg 202 is shown. The length adjustable robotic leg can be the same or similar to the robotic leg 102 of the robotic system 100. The robotic leg 202 can comprise a hip joint assembly 206b comprising a hip joint of the robotic leg 202, a knee joint assembly 206c comprising a knee joint of the robotic leg 202, and an ankle joint assembly 206d comprising an ankle joint of the robotic leg 202. Structural members 204c-d can be disposed between the joint assemblies 206b-d. Specifically a structural member 204c corresponding to a human upper leg can extend between the hip joint assembly 206b and the knee joint assembly 206c, and a structural member 204d corresponding to a human lower leg can extend between the knee joint assembly 206c and the ankle joint assembly 206d.

The structural members 204c-d can interface with the joint assemblies 206b-d such that a distance or length between the joint assemblies 206b and 206c and a distance or length between the joint assemblies 206c and 206d are variable. Simultaneously, each of the joint assemblies 206b-206d can still provide one or more degrees of freedom of movement for the structural members 204c-d interfaced with the joint assemblies 206b-d.

For example, a distance or length between the joint assemblies 206b and 206c in the configuration shown in FIG. 2A is shorter than the distance or length between the joint assembly 206b and 206c in the configuration shown in FIG. 2B. Similarly, a distance or length between the joint assemblies 206b and 206c in the configuration shown in FIG. 2B is shorter than the distance or length between the joint assembly 206b and 206c in the configuration shown in FIG. 2C. Thus, an upper leg portion of the robotic leg 202 can be adjustable to different lengths. Likewise, a distance or length between the joint assemblies 206c and 206d in the configuration shown in FIG. 2A is shorter than the distance or length between the joint assembly 206c and 206d in the configuration shown in FIG. 2B. A distance or length between the joint assemblies 206c and 206d in the configuration shown in FIG. 2B is shorter than the distance or length between the joint assembly 206c and 206d in the configuration shown in FIG. 2C. Thus, a lower leg portion of the robotic leg 202 can be adjustable to different lengths. Therefore, in the different configurations shown in FIGS. 2A-2C, the distance or length between the joint assemblies 206b and 206c, and the distance or length between the joint assemblies 206c and 206d, can be selectively varied based on, for example, a length of the user's leg using the exoskeleton robotic system 100.

The structural members 204c and 204d can both be configured to be actuated by (or otherwise moveable in one or more degrees of freedom with respect to) the joint assemblies 206b and 206c, respectively, as discussed herein, and to facilitate the length adjustment of the robotic leg 202. For example, the structural member 204c can be actuated in a manner by the hip joint assembly 206b so as to achieve hip flexion and extension. Furthermore, the structural member 204c can be caused to rotate relative to the hip joint assembly 206b so as to achieve hip medial/lateral rotation. At the same time, the structural member 204c can interface with the knee joint assembly 206c in a manner so as to facilitate length adjustment of the upper portion of the robotic leg 202.

Similarly, the structural member 204d can be actuated in a manner by the knee joint assembly 206c so as to achieve knee flexion and extension. Additionally, the structural member 204d can be caused to rotate relative to the knee joint assembly 206c so as to achieve ankle medial/lateral rotation. At the same time, the structural member 204d can interface with the ankle joint assembly 206d in a manner so as to facilitate length adjustment of the lower portion of the robotic leg 202. Thus, the robotic leg 202 can provide multiple operational degrees of freedom while also being length adjustable. The interfaces between the joint assemblies 206b-206d and structural members 204c, 204d facilitating the degrees of freedom and length adjustment will be discussed in more detail below with reference to FIGS. 2A-4F.

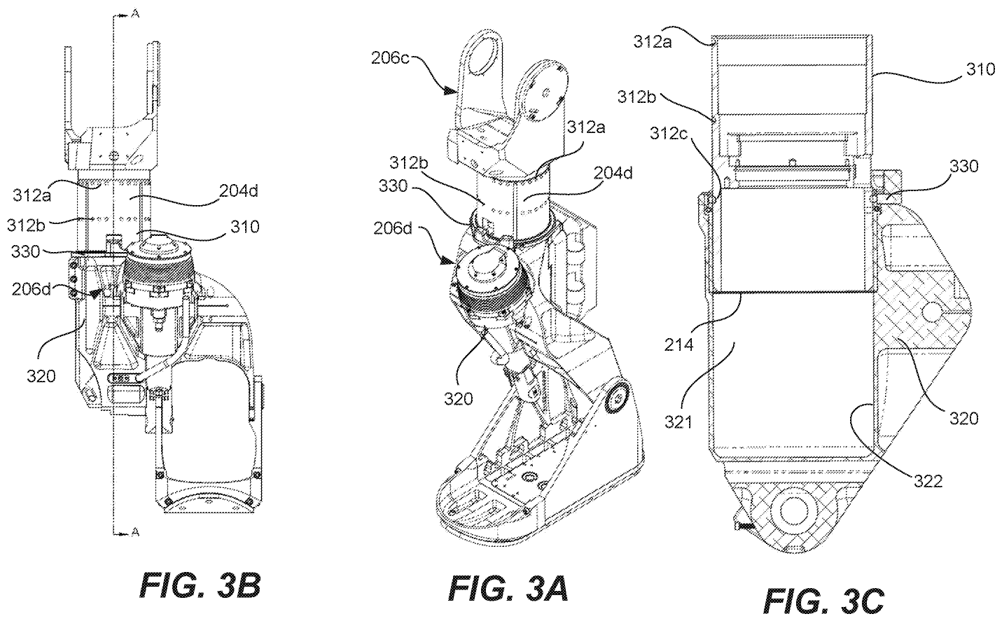

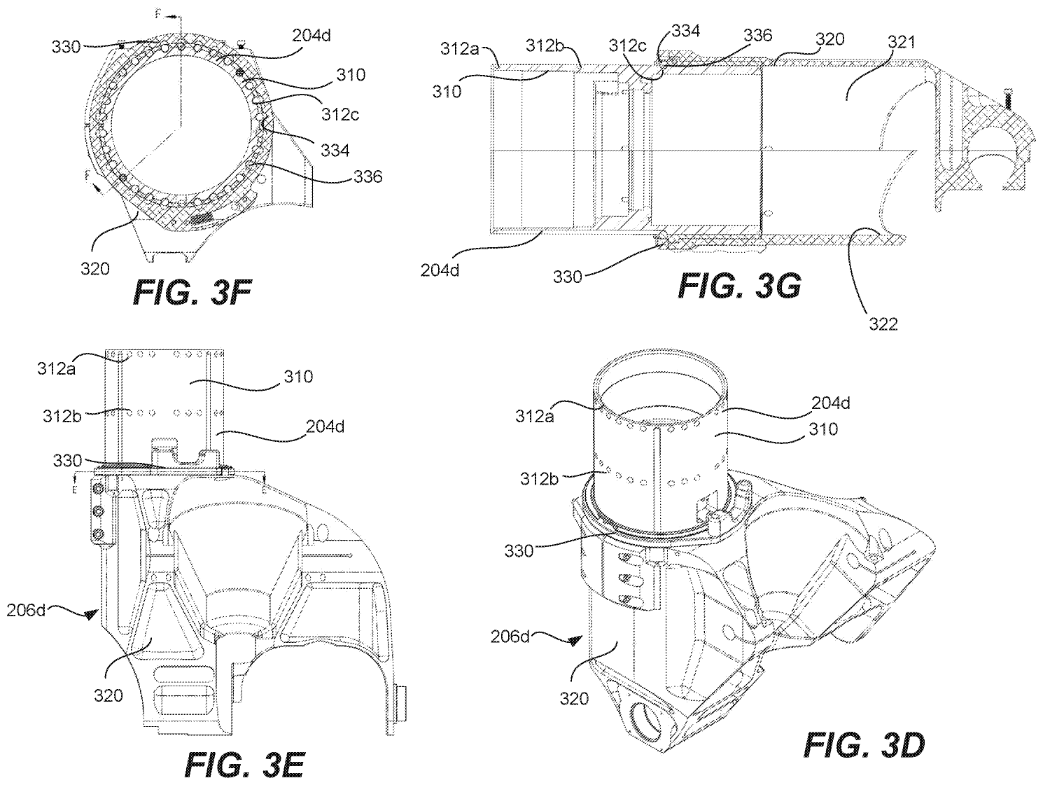

FIGS. 3A-3G are various views of a lower portion of the robotic leg 202 showing an adjustable interface between the structural member 204d and the ankle joint assembly 206d. The robotic leg 202 can be the same as or similar to the robotic leg 102 of the exoskeleton robotic system 100 of FIGS. 1A and 1B. The lower portion of the robotic leg 202 can be length adjustable to facilitate a plurality of length adjustment positions of the lower portion of the robotic leg 202. In this example, the structural member 204d corresponding to a lower leg of a human can comprise a cylindrical shaft 310. The shaft 310 can be configured to be actuated by the knee joint assembly 206c to achieve knee flexion/extension and to rotate relative to the knee joint assembly 206c to achieve ankle medial/lateral rotation as discussed above (see FIGS. 2A-2C).

At one end, the shaft 310 can be rotatably coupled to the knee joint assembly 206c in any manner so as to provide a rotational interface operable to facilitate relative rotation between the knee joint assembly 206c and the structural member 204d about the longitudinal axis in a degree of freedom corresponding to ankle medial/lateral rotation of a human limb. For example, the knee joint assembly 206c can be connected to the structural member 204d via an annular bearing facilitating relative rotation of the knee joint assembly 206c and the structural member 204d.

At the other end, the shaft 310 can be adjustably coupled to the ankle joint assembly 206d via an adjustable interface. Indeed, the adjustable interface can comprise locking interfaces 312a, 312b, 312c disposed at intervals along a length of the shaft 310. The locking interfaces can facilitate adjustably securing the shaft 310 relative to the ankle joint assembly 206d at different positions along the length of the shaft 310, to thereby adjust the length of the lower portion of the robotic leg 202. In this example, the locking interfaces 312a, 312b, 312c can each comprise an array of indents or depressions that extend circumferentially around the shaft 310. The length between the intervals of the locking interfaces 312a, 312b, 312c can be any suitable length depending on a desired interval for length adjustment of the lower portion of the leg. Furthermore, while three locking interfaces 312a, 312b, 312c are shown in this example, more or less locking interfaces can be included depending on the desired interval for the leg adjustment. In one example, the length between locking interfaces can be one-half inch. In other examples, the length between locking interfaces can be as little as one-fourth inch or as great as two inches. Obviously these are merely examples, and those skilled in the art will recognize that other lengths between locking interfaces can be implemented.

The ankle joint assembly 206d can comprise a housing 320 with an opening 321 comprising an inner surface 322. The inner surface 322 can interface with the shaft 310 of the structural member 204d. For example, the shaft 310 can be sized and configured to be inserted into the opening 321 and interface with the inner surface 322 of the opening 321. The shaft 310 can be inserted into the opening 321 to a desired depth corresponding to a desired length of the robotic leg 202. The adjustable interface can further comprise a mechanical lock disposed on the ankle joint assembly 206d. The mechanical lock can be operable to selectively lock the shaft 310 to the ankle joint assembly 206d in one of the plurality of length adjustment positions. In this example, the mechanical lock can comprise a clamp 330 disposed at a top of the opening 321 that is configured to interact with the locking interfaces 312a, 312b, 312c to lock the shaft 310 at a desired depth within the opening 321. In one example, the clamp 330 can comprise a servo clamp. The clamp 330 can comprise an array of indents or depressions 334 that support and accommodate spherical balls 336. The array of indents 334 can correspond with the array of indents of the locking interfaces 312a, 312b, 312c, such that the spherical balls 336 can be inserted into one of the arrays of indents of the locking interfaces 312a, 312b, 312c. When the clamp 330 is actuated (such as via a servomotor, via tightening screws, or via any other known mechanism for tightening a clamp), the interface between the indents 334, the spherical balls 336 and the indents of the desired locking interface 312a, 312b, or 312c, locks the shaft 310 with respect to the ankle joint assembly 206d at a desired length adjustment position, wherein the shaft 310, as locked to the ankle joint assembly 206d, models a rigid rod or shaft in the selected length adjustment position. The clamp 330 is operable to lock the shaft 310 with respect to the ankle joint assembly both longitudinally and circumferentially (i.e., translationally and rotationally). In this manner, the shaft 310 of the structural member 204d that is actuated by the knee joint assembly 206c is selectively length adjustable via the interface with the ankle joint assembly 206d. To achieve a different length adjustment position, the clamp 330 can be actuated to loosen and unlock the interface between the shaft 310 and the ankle joint assembly 206d, wherein the depth of the shaft 310 within the opening 321 can be adjusted to a different length adjustment position (a different one of locking interfaces 312a, 312b, or 312c) corresponding to a different desired length of the robotic leg 202.

It should be noted that while the above example comprises arrays of indents 335 in the clamp 330 accommodating spherical balls 336, other configurations could be used, such as the clamp 330 comprising an array of protrusions configured to interface with the indents of the locking interfaces 312a, 312b, 312c. Further, the locking interfaces 312a, 312b, 312c could comprise protrusions that engage with the indents 335 of the clamp 330. Further, while the above example shows the adjustable interface being operable between the ankle joint assembly 206d and the structural member 204d, the adjustable interface could be incorporated between the knee joint assembly 206c and the structural member 204d. Similarly, the rotational interface could be between the ankle joint assembly 206d and the structural member 204d. Also, while the rotational interface and the adjustable interface were shown to be incorporated on different ends of the structural member 204d (i.e. between structural member 204d and knee joint assembly 206c and between structural member 204d and ankle joint assembly 206d, respectively), the rotational interface and the adjustable interface can be incorporated on one end of the structural member (i.e. can both be incorporated between one of the structural member 204d and knee joint assembly 206c or structural member 204d and ankle joint assembly 206d).

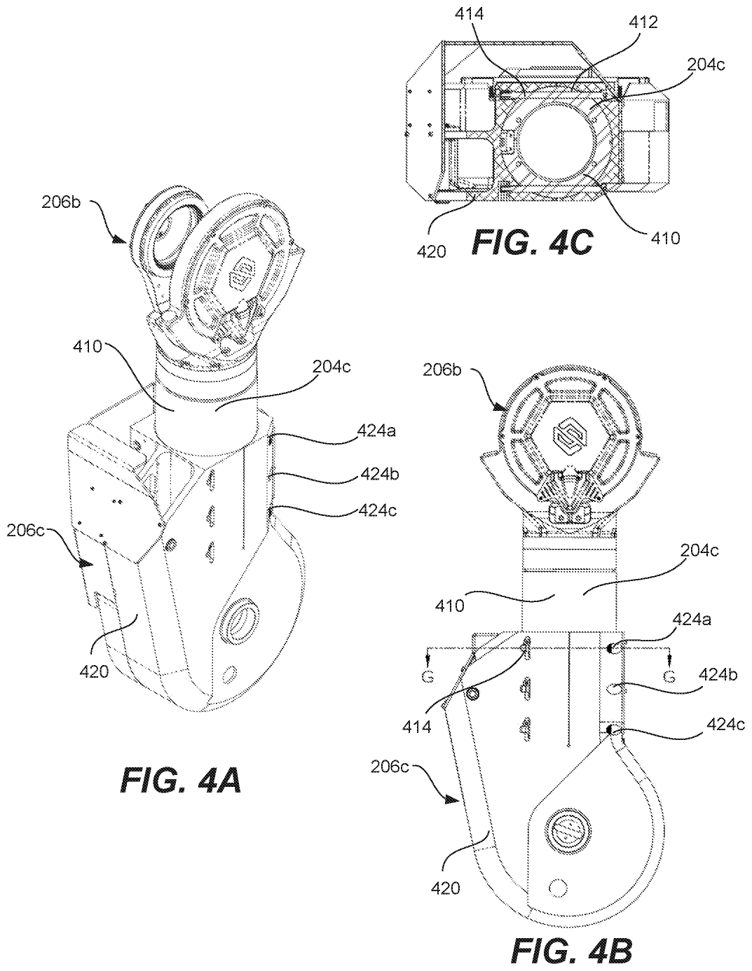

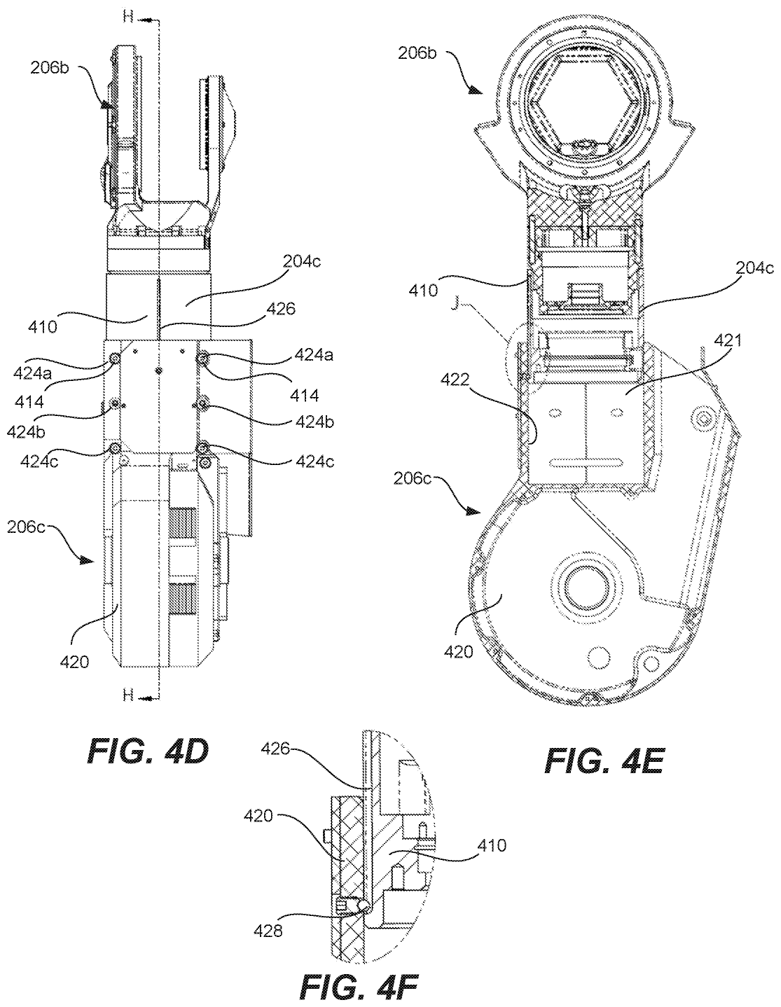

FIGS. 4A-4F are various views of an upper portion of the robotic leg 202 of FIGS. 2A-2C, which can be the same as or similar to the robotic leg 102 of the exoskeleton robotic system 100 of FIGS. 1A-1B. The upper portion of the robotic leg 202 can be length adjustable to facilitate a plurality of length adjustment positions of the upper portion of the robotic leg 202. In this example, the structural member 204c corresponding to an upper leg of a human can comprise a cylindrical shaft 410. The shaft 410 can be configured to be actuated by the hip joint assembly 206b to achieve hip flexion/extension and to rotate relative to the hip joint assembly 206b to achieve hip medial/lateral rotation (see FIGS. 2A-2C).

At one end, the shaft 410 can be rotatably coupled to the hip joint assembly 206b in any manner so as to provide a rotational interface operable to facilitate relative rotation between the hip joint assembly 206b and the structural member 204c about the longitudinal axis in a degree of freedom corresponding to hip medial/lateral rotation. For example, the hip joint assembly 206b can be connected to the structural member 204c via an annular bearing facilitating relative rotation of the hip joint assembly 206b and the structural member 204c.

At the other end, the shaft 410 can be adjustably coupled to the knee joint assembly 206c via an adjustable interface. Indeed, the adjustable interface can comprise a locking interface 412 disposed on the shaft. The locking interface 412 can comprise a hole extending at least partially through (and in some examples all the way through) the sidewall of the shaft 410. The adjustable interface can further comprise a mechanical lock, such as fastener 414. The hole of the locking interface 412 can be sized and configured to receive the mechanical lock (e.g., fastener 414). In one example, the fastener 414 can comprise a bolt. In the example shown in FIGS. 4A-4F, the adjustable interface can comprise two locking interfaces 412 that are positioned parallel to one another on the shaft 410 (e.g., see two through holes extending through the sidewall of the shaft 410 in FIG. 4C) and that each can receive a fastener 414. The locking interfaces 412 can facilitate adjustably securing the shaft 410 relative to the knee joint assembly 206c at different positions relative to the knee joint assembly 206c, to thereby adjust the length of the upper portion of the robotic leg 202.

The knee joint assembly 206c can comprise a housing 420 with an opening 421 comprising an inner surface 422. The inner surface 422 can interface with the shaft 410 of the structural member 204c. For example, the shaft 410 can be sized and configured to be inserted into the opening 421 and interface with the inner surface 422 of the opening 421. The shaft 410 can be inserted into the opening 421 to a desired depth corresponding to a desired length of the robotic leg (such as robotic leg 202 shown in FIGS. 2A-2C). The adjustable interface can further comprise a plurality of fastener guides 424a, 424b, 424c that are disposed at different positions on the knee joint assembly 206c. The fastener guides 424a, 424b, 424c are each operable to receive the fastener at the different positions to lock the shaft 410 at different length adjustment positions along the knee joint assembly 206c to selectively lock the shaft 310 to the ankle joint assembly 206d, thereby providing a plurality of length adjustment positions.

In this example, the fastener guides 424a, 424b, 424c can each comprise two openings in the housing 420 that are parallel to one another to receive the fastener 414. The distance between the fastener guides 424a, 424b, 424c can be any suitable length depending on a desired interval for length adjustment of the upper portion of the leg. Furthermore, while three fastener guides 424a, 424b, 424c are shown in this example, more or less fastener guides can be included depending on the desired interval for the leg adjustment. In one example, the length between fastener guides can be one-half inch. In other examples, the length between fastener guides can be as little as one-fourth inch or as great as two inches. Obviously these are merely examples, and those skilled in the art will recognize that other lengths between fastener guides can be implemented.

To ensure that the fastener guides 424a, 424b, 424c on the housing 420 of the knee joint assembly circumferentially align with the locking interfaces 412 of the shaft 410 of the structural member 204c, the shaft 410 can comprise a guide channel 426 that extends longitudinally along the shaft 410. The housing 420 can comprise a biased spherical ball 428 that is sized and configured to extend into the guide channel 426. As the shaft 410 moves in the opening 421, the spherical ball 428 can keep the shaft 410 circumferentially aligned, such that when the interfaces 412 align with a desired one of the fastener guides 424a, 424b, 424c, the fasteners 414 can be inserted to lock the shaft 410 relative to the knee joint assembly 206c. In this example, the mechanical lock comprising the fastener 414 can lock the shaft 410 longitudinally and circumferentially relative to the knee joint assembly 206c.

While the above example shows the adjustable interface being operable between the knee joint assembly 206c and the structural member 204c, the adjustable interface could be incorporated between the hip joint assembly 206b and the structural member 204c. Similarly, the rotational interface could be between the knee joint assembly 206c and the structural member 204c. Also, while the rotational interface and the adjustable interface were shown to be incorporated on different ends of the structural member 204c (i.e. between structural member 204c and hip joint assembly 206b and between structural member 204c and knee joint assembly 206c, respectively), the rotational interface and the adjustable interface can be incorporated on one end of the structural member (i.e. can both be incorporated between one of the structural member 204c and hip joint assembly 206b or structural member 204c and knee joint assembly 206c).

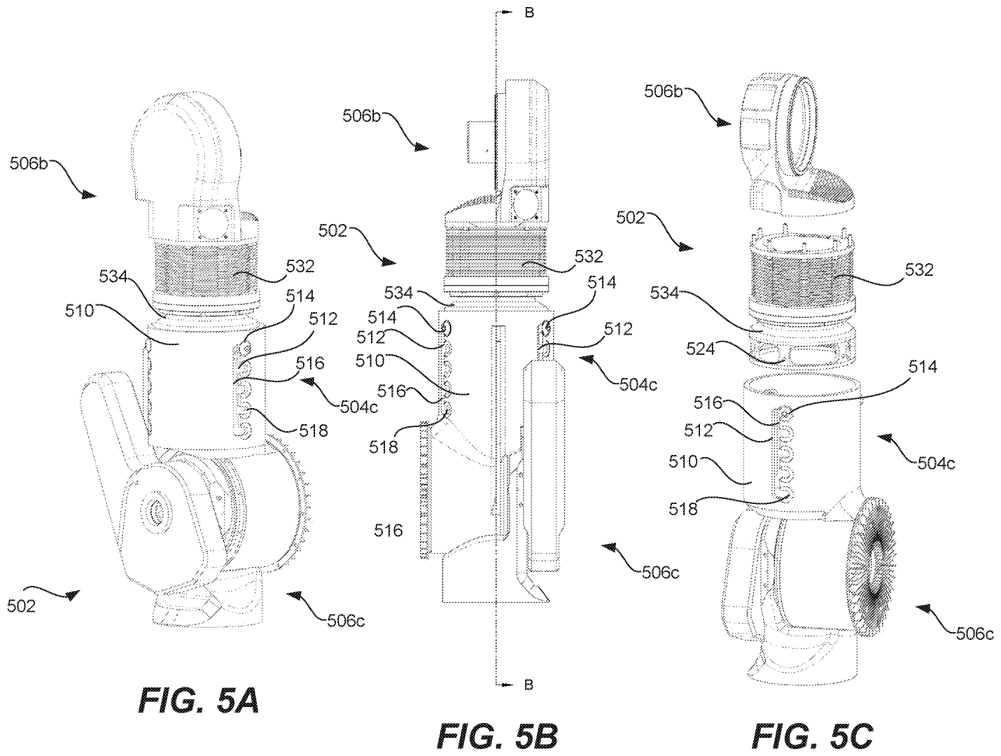

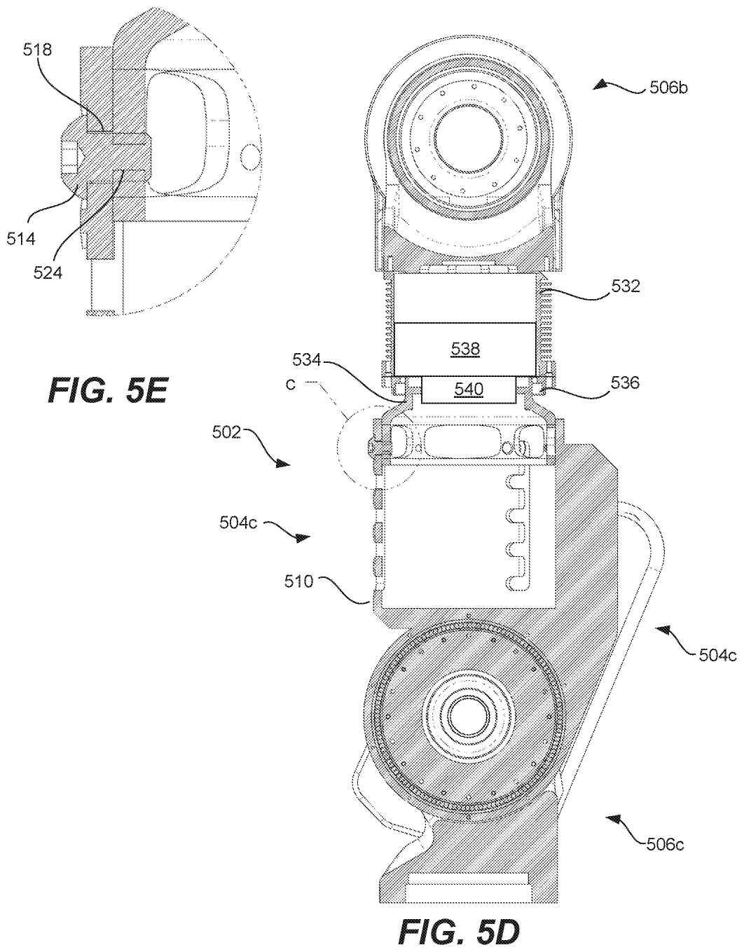

FIGS. 5A-5E are various views of an upper portion of a robotic leg 502. The robotic leg 502 can be the same as or similar to robotic leg 202 of FIGS. 2A-2C, which can be the same as or similar to the robotic leg 102 of the exoskeleton robotic system 100 of FIGS. 1A-1B. The upper portion of the robotic leg 502 shown in FIGS. 5A-5E can comprise a hip joint assembly 506b, a knee joint assembly 506c, and a structural member 504c extending between the hip joint assembly 506b and the knee joint assembly 506. Thus, in this example, the structural member 504c can correspond to an upper leg of a human.

The structural member 504c can comprise a cylindrical shaft 510. The shaft 510 can be configured to be actuated by the hip joint assembly 506b to achieve hip flexion/extension and to rotate relative to the hip joint assembly 506b to achieve hip medial/lateral rotation. At one end, the shaft 510 can be rotatably coupled to the hip joint assembly 506b in any manner so as to provide a rotational interface operable to facilitate relative rotation between the hip joint assembly 506b and the structural member 504c about the longitudinal axis in a degree of freedom corresponding to hip medial/lateral rotation. At another end, the shaft 510 can be attached to the knee joint assembly 506c. In some examples, the shaft 510 can be rigidly attached to the knee joint assembly 506c or can be formed integrally with the knee joint assembly 506c.

In this example, the hip joint assembly 506b can comprise a fixed member 532 and a rotatable member 534. The shaft 510 can couple to the rotatable member 534, as will be explained in more detail below. Accordingly, the fixed member 532 and rotation member 534 together form at least part of the rotational interface between the hip joint assembly 506b and the structural member 504c. The fixed member 532 can be formed to extend from the hip joint assembly 506b. For example, the fixed member 532 can be formed as an integral part of the hip joint assembly 506b and can be rigidly coupled thereto. The rotatable member 534 can be operable to rotationally attach to fixed member 532. In one example, the fixed member 532 can rotationally attach to the rotatable member 534 via an annular bearing 536. The annular bearing 536 facilitates relatively low friction rotation between the fixed member 532 and the rotatable member 534. It is noted that while the terms “fixed” member and “rotational” are used to describe the fixed member 532 and the rotatable member 534, this use is simply for convenience in explanation. It will be understood that these members rotate relative to one another, Thus, either the fixed member 532 or the rotatable member 534 can be stationary while the other of the fixed member 532 or the rotatable member 534 rotates. Similarly, both fixed member 532 and the rotatable member 534 can be rotating simultaneously at different speeds and/or in different directions.

In some examples, the relative rotation between the fixed member 532 and the rotatable member 534 can be caused by the strength of a user of a robotic exoskeleton, such as the robotic system 100 in the form of a robotic exoskeleton shown in FIGS. 1A and 1B. In other words, the relative rotation between the fixed member 532 and the rotatable member 534 can be manually operated.

In another example, the relative rotation between the fixed member 532 and the rotatable member 534 can be powered. In this example, the fixed member 532 can comprise an actuator 538. The actuator 538 can be any known and suitable actuator to facilitate rotational movement. For example, the actuator 538 can comprise an electric motor and optionally a transmission connected to the electric motor. The actuator 538 can connect to an output 540 such as an output shaft that is coupled to the rotatable member 540. In operation, the actuator 538 can rotate the output 540, thereby rotating the rotatable member 534 relative to the fixed member 532. The actuator 538, output 540, and annular bearing 536 can thus also be considered part of the rotational interface between the hip joint assembly 506b and the structural member 504c.

The robotic leg 502 can further facilitate a plurality of length adjustment positions of the upper portion of the robotic leg 502. To this end, the robotic leg 502 can comprise an adjustable interface that facilitates the plurality of length adjustment positions to adjust the length of the upper portion of the robotic leg 502, or a length between the hip joint assembly 506b and the knee joint assembly 506c. The adjustable interface can comprise locking interfaces 512. The locking interfaces can facilitate adjustable securing of the shaft 510 relative to the hip joint assembly 506b at different positions along the length of the shaft 510 to thereby adjust the length of the upper portion of the robotic leg 502.

In this example, the locking interfaces 512 can comprise longitudinal slots 516 extending along a length of the shaft 510 and a plurality of lateral notches 518 that are formed to extend generally perpendicular from the longitudinal slots 516 at desired intervals. The space between the lateral notches 518 can be one-half inch in one example. In another example, the space between the lateral notches 518 can be one inch. Of course, the space between the lateral notches 518 can be set at any desired distance based on the desired intervals between adjustment positions. In the example shown in FIGS. 5A-5E, three longitudinal slots 516 annularly spaced at equal distances are incorporated in the shaft 510. However, this is not intended to be limiting as fewer or more slots 516 could be formed in the shaft 510 and can be spaced apart from one another at any distance, as desired.

The adjustable interface can further comprise a mechanical lock in the form of fasteners 514. The fasteners 514 can be screws that each has a shaft that can extend into the slots 516 and lateral notches 518 and a head sized sufficiently wide that it cannot enter into the slots 516 or the lateral notches. The rotatable member 534 of the hip assembly 506b can comprise holes 524 that are operable to receive the shafts of the of fasteners 514. For example, the holes 524 can comprise a female thread that is operable to receive a corresponding male thread of the fasteners 514.

In operation, to adjust the upper portion of the robotic leg 502 to have a desired distance or length between the hip assembly 506b and the knee assembly 506c, the shaft 510 can receive the rotatable member 534 such that the holes 524 or the rotatable member 534 align with desired notches 518 connected to the slots 516. The fasteners 514 can be inserted through respective lateral notches 518 and into the holes 524. By tightening the fasteners 514 while in the desired respective lateral notches 518, the distance between the hip assembly 506b and the knee assembly 506c can be set.

To change the distance between the hip assembly 506b and the knee assembly 506c, the fasteners 514 can be loosened until the fasteners 514 are free to move from the lateral notches 518 and into the slots 516. This can be done by rotating the shaft 510 relative to the hip assembly 506b about a longitudinal axis such that the fasteners 514 are removed from respective lateral notches 518 into the slots 516. The shaft 510 can then be moved relative to the hip assembly in a longitudinal direction until the fasteners 514 in the holes 524 of the rotatable member 534 are longitudinally aligned with new desired lateral notches 518. When aligned with the new desired lateral notches 518, the shaft 510 can again be rotated relative to the hip assembly 506b about the longitudinal axis such that the fasteners 514 are inserted into the new desired lateral notches 518. The fasteners 514 are again tightened to set the distance between the hip assembly 506b and the knee assembly 506c. This length adjustment can be facilitated between the hip assembly 506b and the knee assembly 506c while still allowing relative rotation between the hip assembly 506b and the knee assembly 506 via the rotational interface discussed above.

Thus, through using the examples of adjustable interfaces discussed above, the combination of the upper portion and the lower portion of a robotic leg, such as robotic leg 202, can be length adjustable while also providing multiple degrees of freedom. For example, the hip joint assembly 206b can facilitate movement of the structural member 204c in flexion/extension and medial/lateral rotation while the adjustable interface between the structural member 204c and knee joint assembly 206c allows the upper portion of the robotic leg 202 to be length adjustable. Likewise, the hip joint assembly 506b can facilitate movement of the structural member 504c in flexion/extension and medial/lateral rotation while the adjustable interface between the structural member 504c and hip joint assembly 506b allows the upper portion of the robotic leg 502 to be length adjustable. Similarly, the knee joint assembly 206c can facilitate movement of the structural member 204d in flexion/extension and medial/lateral rotation while the adjustable interface between the structural member 204d and the ankle joint assembly 206d allows the lower portion of the robotic leg 202 to be length adjustable. The ankle joint assembly 206d can also facilitate flexion/extension and medial/lateral rotation of a structural member corresponding to a human foot (see, e.g., member 104e in FIGS. 1A and 1B). Thus, the robotic leg 202 can provide six degrees of freedom while also being length adjustable in one or more locations.

By incorporating adjustable legs such as the robotic leg 202 or robotic leg 502 into a robotic system, such as robotic system 100 in the form of a robotic exoskeleton, the robotic system can be adjustable for people of different sizes. In one example, the robotic system 100 described herein can accommodate users from five feet tall to six feet, two inches tall. In this example, the upper portion and the lower portion of the robotic leg can be independently length adjustable. However, the robotic leg could be configured to adjust the upper and lower leg portions simultaneously because the ratio of the upper leg to the lower leg tends to be similar among people of all heights.

It is noted that the adjustment interface described above and shown in FIGS. 3A-3G can be used in place of the adjustment interface described above and shown in FIGS. 4A-4F, and vice versa. Further, the adjustment interface and rotational interface described above and shown in FIGS. 5A-5E can be used in place of the locking interfaces and rotational interfaces that make up parts of the length adjustment systems described above and shown in each of FIGS. 3A-3G and FIGS. 4A-4F. In addition, while in some examples the adjustment interface is between the structural member and a first joint assembly and the rotational interface is between the structural member and a second joint assembly, the length adjustment interface and rotational interface can be swapped or can be integrated into an interface with just one of the first and second joint assemblies to provide length adjustment and movement in multiple degrees of freedom. Furthermore, while the length adjustment system examples shown herein are length adjustable at particular discrete intervals, the robotic leg could also be configured to be length adjustable to an infinite number of positions. For example, instead of using the clamp or fastener type of locks as described above that locks the structural member at discrete intervals, a mechanical lock can comprise a friction enhancing device that can selectively lock the respective structural member to the respective joint assembly at any position.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein may be combined with other embodiments or features described herein, this disclosure should be read to describe any such combinations that would be practicable by one of ordinary skill in the art. The use of “or” in this disclosure should be understood to mean non-exclusive or, i.e., “and/or,” unless otherwise indicated herein.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

1. A length adjustable robotic limb comprising:
a first joint assembly comprising a first joint of the robotic limb;
a second joint assembly comprising a second joint of the robotic limb;
a structural member extending between the first joint assembly and the second joint assembly, and defining a longitudinal axis, wherein the structural member is operable to connect with the first joint assembly and the second joint assembly;
an adjustable interface one of between the structural member and the first joint assembly or between the structural member and the second joint assembly, the adjustable interface facilitating adjustment of a length between the first joint assembly and the second joint assembly along the longitudinal axis; and
a rotational interface one of between the structural member and the first joint assembly or between the structural member and the second joint assembly, the rotational interface operable to facilitate relative rotation between the first joint assembly and the second joint assembly about the longitudinal axis in a degree of freedom corresponding to medial/lateral rotation of a portion of a human limb.

2. The length adjustable robotic limb of claim 1, wherein the adjustable interface comprises a mechanical lock operable to selectively lock the structural member to the first joint assembly or the second joint assembly in one of a plurality of length adjustment positions.

3. The length adjustable robotic limb of claim 2, wherein the mechanical lock comprises a clamp disposed on one of the first joint assembly or the second joint assembly, the clamp being configured to engage the structural member at one of the plurality of length adjustment positions to selectively lock the structural member to one of the first joint assembly or the second joint assembly.

4. The length adjustable robotic limb of claim 3,
wherein the structural member comprises a cylindrical shaft,
wherein the adjustable interface further comprises a plurality of locking interfaces disposed at intervals along a length of the shaft, the plurality of locking interfaces each comprising an array of indents extending circumferentially around the shaft, and the plurality of locking interfaces corresponding with the plurality of length adjustment positions; and
wherein the clamp is configured to engage the shaft at one of the locking interfaces to selectively lock the shaft to one of the first joint assembly or the second joint assembly at the one of the plurality of length adjustment positions.

5. The length adjustable robotic limb of claim 4, wherein the clamp comprises an array of depressions, the array of depressions accommodating spherical balls and corresponding to the array of indents of each of the plurality of locking interfaces, and wherein the clamp is configured to engage the array of depressions accommodating the spherical balls with the array of indents of one of the plurality of locking interfaces.

6. The length adjustable robotic limb of claim 1, wherein the adjustable interface comprises a plurality of locking interfaces along a length of the structural member, the plurality of locking interfaces corresponding to a plurality of length adjustment positions.

7. The length adjustable robotic limb of claim 6, wherein the adjustable interface comprises a mechanical lock comprising a clamp disposed on the one of first joint assembly or the second joint assembly, the clamp configured to engage the structural member at one of the locking interfaces.

8. The length adjustable robotic limb of claim 6, wherein the plurality of locking interfaces each comprise longitudinal slots extending along a length of the shaft and a plurality of lateral notches extending perpendicular from the longitudinal slots, the plurality of lateral notches corresponding to the plurality of length adjustment positions.

9. The length adjustable robotic limb of claim 8, wherein the adjustable interface comprises a mechanical lock comprising a fastener operable to couple the structural member to one of the first joint assembly or the second joint assembly at one of the plurality of lateral notches.

10. The length adjustable robotic limb of claim 1, wherein the adjustable interface comprises a mechanical lock comprising at least one fastener configured to one of extend through the structural member and the first joint assembly or extend through the structural member and the second joint assembly at one of the plurality of length adjustment positions to selectively lock the structural member to one of the first joint assembly or the second joint assembly.

11. The length adjustable robotic limb of claim 1, wherein the adjustable interface comprises a plurality of fastener guides disposed on one of the first joint assembly or the second joint assembly, the plurality of fastener guides corresponding to a plurality of length adjustment positions.

12. The length adjustable robotic limb of claim 11, wherein the adjustable interface comprises a mechanical lock comprising at least one fastener configured to extend through the structural member and through one of the first joint assembly or the second joint assembly at one of the plurality of fastener guides.

13. The length adjustable robotic limb of claim 12, wherein the at least one fastener comprises a first and second fastener, and wherein the plurality of fastener guides each comprise two openings parallel to one another that are each operable to receive the first and second fastener, respectively.

14. The length adjustable robotic limb of claim 13, wherein the adjustable interface comprises a first and second locking interface disposed on the structural member, each of the first and second locking interfaces comprising a through hole to receive the first and second fastener, respectively.

15. The length adjustable robotic limb of claim 14, wherein the structural member comprises an alignment channel extending longitudinally along the structural member, and the second joint assembly comprises a biased spherical ball operable to extend into the alignment channel and to circumferentially align the two openings of the plurality of fastener guides and the first and second locking interfaces of the structural member.

16. The length adjustable robotic limb of claim 1, wherein the first joint is a hip joint of the robotic limb, the second joint is a knee joint of the robotic limb, and the structural member comprises an upper leg structural member between the hip joint and the knee joint.

17. The length adjustable robotic limb of claim 16, further comprising:
a third joint assembly disposed at an ankle joint of the robotic limb; and
a lower leg structural member extending between the second joint assembly and the third joint assembly, and defining a lower leg longitudinal axis, wherein the lower leg structural member is operable to connect with the second joint assembly and the third joint assembly;
a second adjustable interface one of between the lower leg structural member and the second joint assembly or between the lower leg structural member and the third joint assembly, the second adjustable interface facilitating adjustment of a length between the second joint assembly and the third joint assembly along the lower leg longitudinal axis; and
a second rotational interface one of between the lower leg structural member and the second joint assembly or between the lower leg structural member and the third joint assembly, the second rotational interface operable to facilitate relative rotation between the second joint assembly and the third joint assembly about the lower leg longitudinal axis in a degree of freedom corresponding to medial/lateral rotation of a portion of a human limb.

18. The length adjustable robotic limb of claim 17, wherein the adjustable interface and the second adjustable interface are independently adjustable.

19. The length adjustable robotic limb of claim 1, wherein the rotational interface comprises a fixed member and a rotatable member disposed at one of the first joint assembly or the second joint assembly, the rotatable member operable to rotate relative to the fixed member, wherein the structural member is connected to the rotatable member such that rotation of the rotatable member facilitates the relative rotation between the first joint assembly and the second joint assembly about the longitudinal axis.

20. The length adjustable robotic limb of claim 19, wherein the rotational interface further comprises a bearing disposed between the fixed member and the rotatable member.

21. The length adjustable robotic limb of claim 19, wherein the rotational interface further comprises an actuator operable to rotate the rotatable member relative to the fixed member.

22. A length adjustable robotic limb comprising:
a first joint assembly comprising a first joint of the robotic limb;
a structural member extending from the first joint assembly and defining a longitudinal axis,
an adjustable interface between the first joint assembly and the structural member, the adjustable interface facilitating adjustment of a length between the first joint assembly and a second joint assembly connected to the structural member along the longitudinal axis; and
a rotational interface between the first joint assembly and the structural member, the rotational interface operable to facilitate relative rotation between the first joint assembly and the the second joint assembly about the longitudinal axis in a degree of freedom corresponding to medial/lateral rotation of a portion of a human limb.

23. The length adjustable robotic limb of claim 22, wherein the adjustable interface comprises a plurality of locking interfaces along a length of the structural member, the plurality of locking interfaces corresponding to a plurality of length adjustment positions.

24. The length adjustable robotic limb of claim 23, wherein the plurality of locking interfaces each comprise longitudinal slots extending along a length of the shaft and a plurality of lateral notches extending perpendicular from the longitudinal slots, the plurality of lateral notches corresponding to the plurality of length adjustment positions.

25. The length adjustable robotic limb of claim 24, wherein the adjustable interface comprises a mechanical lock comprising a fastener operable to couple the structural member to the first joint assembly at one of the plurality of lateral notches.

26. The length adjustable robotic limb of claim 22, wherein the rotational interface comprises a fixed member and a rotatable member disposed at the first joint assembly, the rotatable member operable to rotate relative to the fixed member, wherein the structural member is connected to the rotatable member such that rotation of the rotatable member facilitates the relative rotation between the first joint assembly and the second joint assembly about the longitudinal axis.

27. The length adjustable robotic limb of claim 26, wherein the rotational interface further comprises a bearing disposed between the fixed member and the rotatable member.

28. The length adjustable robotic limb of claim 26, wherein the rotational interface further comprises an actuator operable to rotate the rotatable member relative to the fixed member.

29. A method of adjusting a length of a robotic limb comprising
connecting a structural member of a robotic limb to a first joint assembly disposed at a first joint of the robotic limb;
selectively locking the structural member to the first joint assembly at a first position of a plurality of length adjustment positions; and
unlocking the structural member from the first position and selectively locking the structural member to the first joint assembly at a second position of the plurality of length adjustment positions;
wherein the structural member is rotatably coupled to one of the first joint assembly or to a second joint assembly disposed at a second joint of the robotic limb, the rotational interface operable to facilitate relative rotation between the first joint assembly and the second joint assembly about the longitudinal axis in a degree of freedom corresponding to medial/lateral rotation of a portion of a human limb.
